(19) United States
(12) Patent Application Publication
(10) Pub. No.: US 2017/0204235 A1
(43) Pub. Date: Jul. 20, 2017

(54) PREPREG MANUFACTURING AND DRYING PROCESS

(71) Applicant: Dow Global Technologies LLC, Midland, MI (US)

(72) Inventor: Nestor A. Vasquez, Shepherd, MI (US)

(73) Assignee: Dow Global Technologies LLC, Midland, MI (US)

(21) Appl. No.: 15/116,413

(22) PCT Filed: Apr. 22, 2015
(86) PCT No.: PCT/US2015/026977

§ 371 Date: Aug. 3, 2016

Related U.S. Application Data
(60) Provisional application No. 61/987,145, filed on May 1, 2014.

(51) Int. Cl. C08J 5/24; B29B 13/06; B29C 70/46; B29B 15/12

(52) U.S. Cl. CPC C08J 5/24; B29B 15/125; B29B 13/06; B29C 70/46; C08J 2363/00; B29K 2105/0845

(57) ABSTRACT

Prepregs are prepared by impregnating a fiber mat with an aqueous dispersion of a thermosetting resin. The resulting wet, impregnated fiber mat is dried by contacting it with streams of elevated temperature gas, such as in an air flotation dryer. This process provides thorough and economical drying without significantly curing the thermoset resin.

The present invention relates to a method for making fiber prepregs.

Fiber reinforced composites are widely used to make a large array of products. The composites include reinforcing fibers that provide mechanical strength and stiffness, and a polymeric phase which binds the fibers together and holds them in the desired configuration.

The composites are often produced from a “prepreg”. The prepreg is formed by impregnating a mat of reinforcing fibers with a resin. This allows the step of wetting the fibers with the resin to be divorced from the molding or other process that is used to form the final part. The ability to do this is often of significant value to the manufacturer of the finished part, who is relieved from purchasing and inventorying multiple starting materials (fiber, resin, curing agents, etc.), operating additional equipment and from the need to handle chemicals. Manufacturing the prepreg separately from part production also can help to more consistently produce a uniformly impregnated material.

Prepregs, therefore, are often manufactured and sold as an item of commerce to parts manufacturers, who mold them or otherwise shape them into parts. They are often sold as rollstock. The resin phase is normally tacky, especially in the most prevalent case in which a thermosetting resin is used. Tackiness has a certain advantage when the prepreg is “laid-up” to form a part, as it allows the prepregs to stick to each other temporarily until the lay-up is cured. To prevent the prepreg from prematurely sticking to itself or to other prepregs during storage and transportation, they often are manufactured and sold with a release covering on one or both sides.

There are two main ways to make prepregs. One way is a hot melt method, in which the resin is a room temperature solid. In this method, the resin is heated to soften it, and the softened resin is then impregnated into the fibers. Typically, a film of the resin is applied to the fiber mat and the assembly is then heated under pressure to force the resin into the interstices between the fibers. The shortcomings of this method are that poor impregnation is achieved when the softened resin is highly viscous; therefore high temperatures are often needed. The high temperatures can degrade the polymer in some instances. When the resin is a thermosetting type, the high temperatures promote a curing reaction, making it difficult to control the extent of cure and produce a consistently high quality product.

The second main way is a solvent-based process. In this process, the binder resin is applied as a solution in a suitable solvent. This allows the resin to be applied as a relatively low viscosity fluid, which facilitates penetration of the resin between and around the fibers. However, the solvent must then be removed, which requires a significant amount of energy and equipment costs. Because the binder resin seldom if ever is water-soluble, the solvent is invariably a volatile organic compound. These solvents present significant flammability risks as well as risks due to exposure to workers.

Some resins are available in the form of aqueous dispersions. Using an aqueous dispersion in a prepreg process in principle offers a route to avoiding organic solvents, as the solvent would be replaced by water, and water rather than the solvent would be removed after the fiber mat is impregnated. Unfortunately, it is much more difficult to remove water than most solvents. Water not only has a higher boiling temperature than most of the common organic solvents, but its heat of vaporization is very high. As a result, the energy required is quite substantial. In addition, the high temperatures needed to effectively remove the water can lead to the problems that come with premature curing.

This invention is a process for forming a prepreg, comprising;

a) continuously impregnating a fiber mat with an aqueous dispersion containing droplets or particles of an uncured thermosetting resin dispersed in a continuous aqueous phase, to form a wet, impregnated fiber mat and then

b) continuously feeding the wet, impregnated fiber mat through a hot air dryer wherein one or more streams of elevated temperature gas are contacted with the wet, impregnated fiber mat to remove water from the wet, impregnated fiber mat and form a dried prepreg that includes the fiber mat impregnated with a curable, thermosetting resin composition comprising the uncured thermosetting resin, the dried prepreg containing 0 to 2.5% of water based on the total weight of the prepreg, and continuously withdrawing the dried prepreg from the dryer.

This drying method is unexpectedly effective. Water is rapidly removed to very low levels. Surprisingly, the gas streams do not blow the deposited thermosetting resin from the fiber mat. An additional surprising advantage is that although drying is effected using elevated temperature gas streams, the thermosetting resin does not cure significantly during the drying process. As a result, this process permits the rapid, continuous and effective preparation of prepregs that have excellent penetration of the resin into the fibers and low water contents. In addition, in preferred embodiments, the prepreg exiting the dryer needs little or no cooling before it can be wound up or otherwise packaged for storage and/or transportation. Often, there is no need to apply a release film to the prepreg before winding or packaging.

In certain aspects, the dryer is an air flotation dryer in which the gas streams support the weight of the mat as it passes through the dryer, causing the mat to “float” through the dryer without need for direct mechanical support within the dryer. Although air flotation drying is used industrially in producing lightweight materials such as paper and cardboard, this process is used rarely if at all to dry materials having area densities as great as that of the wet, impregnated fiber mat or even of the dried prepreg. So, the ability to float the impregnated fiber mat through the dryer is unexpected.

The fiber mat consists of reinforcing fibers that may be entangled, woven, knitted, needle-punched or otherwise formed into a mat. The reinforcing fibers may be, for example, carbon, glass or other ceramic, organic polymer, metal, natural fiber such as wool, cotton, jute and the like, or other fibrous material. Mixtures of fiber types can be used. The fibers may be monofilament fibers or multifilament rovings.

Especially preferred fibers are multifilament rovings (sometimes referred to as “tows”) having 3000 to 30,000 filaments/roving. These multifilament fibers are most preferably carbon fibers. Examples of such carbon fibers are Aksaca 3K A-38, 6K A-38, 12K A-42, 24K A-42, 12K A-49 and 24K A-49 carbon fibers from DowAksa Ileri Kompozit Malzemeler Sanayi Ltd, Sti, Itanbul, Turkey. These product designations indicate the approximate number of filaments/roving in thousands (3K being 3000 filaments, for example) and the approximate tensile strength of the fiber in hundreds of MPa (A-38 indicating a tensile strength of 3800 MPa). Other suitable carbon fibers include 12K and 24K rovings available from Dost Kimya End Hamm Sen Ve Tic Ltd. Sti, Istanbul, Turkey. The carbon content of these fibers may be 80% or more by weight.

Fiber diameters may be, for example, 0.5 to 30 microns, preferably 2 to 15 microns. In terms of fiber weight, the fibers may have a weight of, for example, 200 to 3000 g/1000 meters, 600 to 2000 g/1000 meters, or 750 to 1750 g/1000 meters.

Woven fiber mats may be woven into any suitable pattern, such as a plain weave, a twill weave or a satin weave.

The fiber mat weight may have an area density, for example, of 250 to 1500 g/m², 500 to 1000 g/m² or 500 to 750 g/m².

A preferred fiber mat is a woven carbon fiber mat having an area density of 500 to 1000 g/m², especially 500 to 750 g/m², in which the carbon fibers are multifilament rovings having 3000 to 30,000 filaments, especially 12,000 to 24,000 filaments and the rovings have a weight of 600 to 2000 g/1000 meters, especially 750 to 1750 g/1000 meters. The fiber mat may have a width of, for example, 0.3 meters to 10 meters or more. A preferred width is 0.3 meters to 4 meters.

The aqueous dispersion includes a continuous aqueous phase in which are dispersed droplets (if liquid) and/or particles (if solid) of a thermosetting resin. The number average droplet or particle size of the disperse phase(s) of the aqueous dispersion is preferably no greater than 10 μm, more preferably 0.05 to 5 μm and still more preferably 0.25 to 2 μm. It is especially preferred that 95 number-percent of the dispersed droplets or particles have a particle size of no greater than 10 μm.

The Brookfield viscosity of the aqueous dispersion preferably is no more than 1000 mPas, more preferably no more than 250 mPas at 25° C.

The continuous phase contains water. The water content of the aqueous dispersion is at least 10% by weight and preferably at least 25% by weight. The water content of the aqueous dispersion preferably is no greater than 75%, more preferably no greater than 60% by weight and still more preferably no greater than 50% by weight.

The dispersion preferably contains little or no volatile organic compounds, which for purposes of this invention means organic compounds having a boiling temperature (at one atmosphere pressure) of 80° C. or less. The aqueous dispersion preferably contains no more than 5%, especially no more than 1% by weight volatile organic compounds.

Examples of thermosetting resins that form droplets (if liquid) or particles (if solid) dispersed in the aqueous phase are epoxy resins, phenolic resins, cyanate ester resins, bis(maleimide) resins, unsaturated polyester and vinyl ester polymers. Epoxy dispersions are preferred on the basis of cost, availability and generally beneficial properties.

The aqueous dispersion may contain one or more catalysts and/or curing agents, as may be necessary or desirable to cure the thermosetting polymer after the prepreg is formed. Such catalyst(s) and/or curing agent(s) may reside in the continuous aqueous phase. They may reside in and/or on the surface of the dispersed droplets or particles of the thermosetting resin. For example, the catalyst(s) and/or curing agent(s) may be dissolved in the thermosetting resin or may form a separate phase occluded into the dispersed droplets or particles of the thermosetting resin. The catalysts and/or curing agents may form separate particles and/or droplets dispersed in the aqueous phase.

The aqueous dispersion may contain other ingredients that may be useful or desirable, including, for example, one or more surfactants to stabilize the droplets or particles from coalescing and/or settling out of the dispersion, rheological modifiers such as thixotropic agents or thickeners, colorants, preservatives, biocides, fillers, and the like. Any or all of these ingredients may be absent from the aqueous dispersion.

The selection of thermosetting resin, together with the choice of catalysts and/or curing agents (if present) is made in conjunction with drying conditions (in general, temperature and residence time) such that no significant curing of the thermosetting resin occurs during the drying step.

In the preferred case of an epoxy resin, the aqueous dispersion preferably contains a heat-activated catalyst, a heat-activated curing agent, or both. The heat-activated catalyst or curing agent may be, for example, a solid material that melts and therefore becomes available for reaction, at an elevated temperature. Alternatively, it may be an encapsulated material in which the encapsulant melts or degrade at an elevated temperature to release the active material. The curing agent or catalyst may have blocked reactive or catalytic sites, which thermally deblock at an elevated temperature. This elevated temperature may be, for example, at least 80° C., at least 100° C. or at least 120° C. and preferably is no greater than 200° C., more preferably no greater than 160° C.

Preferably, the components of the applied dispersion are such that the thermosetting resin cures at an elevated temperature of at least 50° C., preferably at least 80° C. and slowly if at all at temperatures below 50° C. The applied coating, after removal of water as described below, preferably requires at least 5 hours to exhibit a 10° C. increase in glass transition temperature when heated to 50° C. and held at that temperature. It preferably requires at least 2 hours to exhibit a 10° C. increase in glass transition temperature when heated to 80° C. and held at that temperature.

The aqueous dispersion is applied to the fiber mat. The method of application is not especially critical, provided that the dispersion wets out the fibers and the resin droplets. The aqueous dispersion can be applied, for example, by spraying, immersing the fiber mat into the dispersion, brushing, pouring, or in other ways. After applying the dispersion to the mat, the dispersion may be forcibly impregnated into the fiber mat using, for example, mechanical means such as a doctor blade, air knife, one or more sets of nip rollers, a double-band laminator, or other apparatus. Such an apparatus may remove excess amounts of the dispersion from the fiber mat to provide a predetermined loading of the dispersion onto the fiber mat.

The amount of aqueous dispersion applied to the fiber mat can be expressed in various ways. In relative terms, the amount of aqueous dispersion that is applied may range, for example, from 5 to 500%, preferably 20 to 200% and more preferably 50 to 100% of the weight of the uncoated fiber mat. In absolute terms, the amount of aqueous dispersion may be, for example, 100 to 2000 g/m², preferably 200 to 1000 g/m² and more preferably 250 to 750 g/m².

Prior to drying, the wet, impregnated fiber mat may have an area density, for example, of 350 to 3500 g/m², from 700 to 2000 g/m², from 800 to 1500 g/m² or from 1000 to 1250 g/m². This represents the area density of the wet, impregnated fiber mat as it enters the dryer.

The water content of the wet, impregnated fiber mat, prior to drying, may be, for example, 5 to 30 weight percent, 10 to 20 weight percent or 13 to 20 weight percent.

The drying step is performed continuously by contacting the wet, impregnated fiber mat with one or more streams of elevated temperature gas.

The flow rates of the elevated temperature gas at the point(s) of contact with the wet, impregnated fiber mat may be, for example, 1 to 1000 m/s, 5 to 100 m/s or 10 to 50 m/s.

The gas is typically air, but other gases such as nitrogen, helium, argon, carbon dioxide and the like also can be used.

The temperature of the gas stream at the point(s) of introduction into the dryer may be, for example, at least 80° C., preferably 80 to 200° C., more preferably 100 to 175° C. and still more preferably 100 to 140° C.

The temperature in the dryer is typically somewhat lower than that of the gas stream(s) due to heat sink effects, expansion of the inject gas and/or other reasons. Typically, the temperature in the dryer is at least 60° C. A preferred temperature is 80 to 175° C. and a more preferred temperature is 100 to 140° C.

The temperature of the wet, impregnated fiber mat (and dried prepreg when it forms) as it passes through the dryer is generally significantly lower than the dryer gas temperature, especially near the entrance where the impregnated fiber mat enters the dryer. The lower temperature of the impregnated fiber mat relative to the dryer gas temperature is believed to be due at least in part to the effect of evaporative drying. Because the impregnated fiber mat is water-wetted, its temperature under a stream of dry gas will tend towards the wet bulb temperature, which will be significantly lower than the temperature of the gas as it is introduced into the dryer. The wet bulb temperature is the temperature produced in a parcel of gas if cooled to saturation by the evaporation of water into it, with the latent heat being supplied by the gas.

Because of this evaporative cooling, the temperature of the gas as it comes in contact with the wet, impregnated fiber mat may be significantly higher than the temperature at which the thermosetting resin cures. Despite the higher gas temperature, the evaporative cooling of the wet, impregnated fiber mat is believed to keep the mat and the resin at a temperature low enough to prevent significant curing from occurring, at least until most of the water has been removed.

After most of the water has been removed from the fiber mat, the temperature of the impregnated fiber mat (and dried prepreg once it is formed) tends to rise towards the gas temperature in the dryer.

A preferred type of dryer is an air flotation dryer. An air flotation dryer is an apparatus in which the wet, impregnated fiber mat is supported on a cushion of heated gas as it is pulled through and is dried to form the prepreg. An air flotation dryer includes multiple nozzles that upwardly and downwardly emit high-speed jets of gas, which balance the weight of the mat. The jets of gas form the cushion that supports the wet, impregnated fiber mat (and dried prepreg as it forms) and provides most if not all of the heat energy for removing water. Because the wet, impregnated fiber mat “floats” on the gas cushion, it typically passes through the dryer without touching a solid mechanical surface. Air flotation dryers are described, for example, by Wimburger, “Curing Coated Webs with Flotation Dryers” in Process Heating, May/June 1995. Air flotation dryers are well known in the paper industry, and suitable dryers of this type are commercially available from various sources, including, for example, Litzler Inc. (Cleveland, Ohio) and MEGTEC Systems, Inc. (De Pere, Wis.).

The wet, impregnated fiber mat preferably is dried in the dryer until the water content is reduced to 2.25 weight percent or less, and preferably to 2 weight percent or less, based on the total weight of the dried prepreg. It has surprisingly been found a water content of up to about 2 weight percent or even slightly more has little adverse effect on the subsequent part-forming process in which the prepreg is shaped and the thermosetting resin cured. Therefore, an advantage of this invention is that drying to very low moisture contents, such as 1 weight percent or less, is not necessary. The ability to leave a small amount of moisture in the prepreg has another important benefit in that the drying conditions (temperature and residence time) can be quite moderate, which reduces the opportunity for premature curing to take place during the drying step. Although the prepreg can be dried to any arbitrarily low water content, it is typically adequate to dry the prepreg to a water content of 1 to 2.25 weight percent, preferably 1.25 to 2 weight percent, thereby avoiding the need for higher dryer temperatures and/or long residence times, both of which increase the possibility of premature curing.

Therefore, in this invention, it is preferred to select operating conditions including dryer temperature and residence time, such that the moisture content of the prepreg is reduced to 2.25 weight percent or less, preferably 1 to 2.25 weight percent and more preferably 1.25 to 2 weight percent, while maintaining the temperature of the wet, impregnated fiber mat and resulting prepreg below that temperature at which the thermosetting resin rapidly cures. The temperature of the wet, impregnated fiber mat and subsequently formed prepreg preferably does not exceed about 120° C. and more preferably does not exceed 100° C. In some embodiments, the process is operated such that the wet, impregnated fiber mat and subsequently formed prepreg attains a temperature within the range of 80 to 120° C. (if at all) for no more than 5 minutes, preferably no more than 3 minutes and even more preferably no more than 2 minutes. In other embodiments, the temperature of the wet, impregnated fiber mat and subsequently formed prepreg in the dryer does not exceed 80° C. for more than 5 minutes and does not exceed 100° C. for more than 2 minutes (if at all). In still other embodiments, the temperature of the wet, impregnated fiber mat and subsequently formed prepreg in the dryer does not exceed 100° C. at any time and does not exceed 80° C. for more than 3 minutes (if at all). In still another embodiment, the temperature of the wet, impregnated fiber mat and prepreg in the dryer does not exceed 80° C. at any time.

In yet other embodiments, the temperature of the coated mat in the dryer does not exceed the Mettler softening temperature of the coating. The “coating”, for purposes of this invention, is the residue of the applied aqueous dispersion after removal of water to within the range described above. The coating will include at least the thermosetting resin, and may contain other ingredients such as, for example, one or more hardeners, one or more catalysts, one or more polymerization or curing initiators, and the like. The coating preferably has a Mettler softening temperature (ASTM D6090-12) of at least 40° C., at least 50° C., or at least 75° C., up to 150° C., preferably up to 135° C.

Residence time is determined mainly by dryer length, line speed and the number of passes through the dryer. These parameters therefore are selected together to reduce the water content of the wet, impregnated fiber mat as described before while preferably maintaining the temperature of the wet, impregnated fiber mat and prepreg as described above. The residence time in the dryer may be, for example, 2 to 30 minutes, or 3 to 15 minutes or 3 to 10 minutes. The dryer length may be, for example, 2 to 30 meters, 3 to 10 meters, or 4 to 8 meters. A single- or multiple-pass dryer may be used.

Line speed is the linear rate at which the wet, impregnated fiber mat and resulting prepreg are moved through the dryer. The line speed may be, for example, 0.1 to 5 meters per minute, 0.25 to 3 meters per minute or 1 to 2 meters per minute. Means are provided for moving the wet, impregnated fiber web and resulting prepreg through the dryer. Such means may be, for example, various types of winding devices, which pull the coated mat through the dryer and wind it into rollstock; various types of drive rollers; a tenter frame; or other suitable apparatus.

If the temperature of the prepreg is at or above the Mettler softening temperature of the coating at the conclusion of the drying step, it is preferred to cool the prepreg to below the Mettler softening temperature of the coating to allow the coating to harden before stacking, winding, packaging, storing or transporting.

The temperature of the dried prepreg may be reduced, for example, to below 40° C. or below 30° C. or even below 25° C. before performing subsequent operations such as stacking, winding, packaging, storing or transporting. Cooling may be done, for example, by passing the prepreg through a cooling zone. In a preferred process, the prepreg is passed continuously through a cooling zone. The cooling zone, for example may include one or more chilled rollers (which may also serve as all or part of the mechanism for pulling the material through the dryer). In such a case, the dried prepreg is passed over and in contact with one or more of the chilled rollers. The cooling zone may include a refrigerated area through which the dried prepreg is passed, or a cooled surface into which the dried prepreg is brought into contact. In some embodiments, the cooling zone may simply be or include a parcel of ambient air that is brought into contact with the dried prepreg.

In an especially preferred process, the prepreg is manufactured in accordance with the invention on apparatus that includes, in sequence, (1) an unwinding station where fiber mat rollstock is unwound and then fed into subsequent steps of the process; (2) a coating station where the aqueous dispersion is applied; (3) the dryer, which is preferably an air flotation dryer; (4) an optional cooling station and (5) a rewinding station where the finished prepreg is wound into rollstock. The rewinding station may also function as the apparatus that pulls the fiber mat through the process.

An unexpected advantage of this process is that the finished prepreg is often substantially tack-free, in preferred embodiments in which the coating has a Mettler softening temperature of 50° C. or higher. Because of this, the prepreg often can be rolled or stacked for storage or transportation without the need to apply a release sheet between adjacent surfaces. This is a significant advantage because the expense of the release sheet can be eliminated, together with the costs of applying the sheet, removing it when the prepreg is used, and then disposing of the used release sheet.

The prepreg may have an area density of, for example, 300 to 3600 g/m², 550 to 1850 g/m², 650 to 1350 g/m² or 800 to 1200 g/m². It may contain, for example, 5 to 60 weight percent of thermosetting resin, 40 to 92.75 weight percent fibers and 0 to 2.25 weight percent water. In other embodiments, the prepreg may contain 20 to 50 weight percent thermosetting resin, 50 to 77.75 weight percent fibers and 0 to 2.25 weight percent water.

In a preferred prepreg, the thermosetting resin composition is a mixture of at least one epoxy resin, at least one epoxy hardener and at least one catalyst for the reaction of the epoxy resin and the hardener. The epoxy hardener and the catalyst preferably are heat-activatable types that become activated at a temperature of at least 50° C. Preferably at least one of the hardener and the catalyst becomes activated at a temperature of at least 80° C., at least 100° C. or at least 120° C. As described before, the mechanism by which the hardener and/or catalyst become activated may be, for example, melting; the loss of an encapsulant through melting or otherwise; thermal de-blocking, or other mechanism.

A wide range of epoxy resins are suitable, including those described at column 2 line 66 to column 4 line 24 of U.S. Pat. No. 4,734,332, incorporated herein by reference, it being preferred that one or more of the epoxy resins is a room temperature solid having a Mettler softening temperature of at least 50° C., preferably at least 80° C. The epoxy resin or resins should have an average of at least 2.0 epoxide groups per molecule. The epoxy resin or resins preferably has an average epoxy equivalent weight of 170 to 2000, more preferably from 170 to 1200 and still more preferably from 170 to 1000.

A preferred type of epoxy resin is a diglycidyl ether of a polyhydric phenol compound such as resorcinol, catechol, hydroquinone, biphenol, bisphenol A, bisphenol AP (1,1-bis(4-hydroxylphenyl)-1-phenyl ethane), bisphenol F, bisphenol K and tetramethylbiphenol. These can have average epoxy equivalent weights of from about 170 to 600 or more, preferably from 225 to 400. Examples of epoxy resins of this type include diglycidyl ethers of bisphenol A such as are sold by The Dow Chemical Company under the designations D.E.R.® 330, D.E.R.® 331, D.E.R.® 332, D.E.R.® 383, D.E.R. 661 and D.E.R.® 662 resins.

Other useful epoxy resins (any of which can be used by themselves or in admixture with one or more others) include, for example, diglycidyl ethers of aliphatic glycols and polyether glycols, such as the diglycidyl ethers of C₂₋₂₄ alkylene glycols and poly(ethylene oxide) or poly(propylene oxide) glycols (including those sold as D.E.R.® 732 and D.E.R.® 736 by The Dow Chemical Company); polyglycidyl ethers of phenol-formaldehyde novolac resins (epoxy novolac resins), including those sold as D.E.N.® 354, D.E.N.® 431, D.E.N.® 438 and D.E.N.® 439 by The Dow Chemical Company; alkyl substituted phenol-formaldehyde resins; phenol-hydroxybenzaldehyde resins; cresol-hydroxybenzaldehyde resins; dicyclopentadiene-phenol resins; cycloaliphatic epoxides including (3,4-epoxycyclohexyl-methyl)-3,4-epoxy-cyclohexane carboxylate, bis-(3,4-epoxycyclohexyl) adipate, vinylcyclohexene monoxide as well as others as described in U.S. Pat. No. 3,686,359; oxazolidone-containing compounds as described in U.S. Pat. No. 5,112,932; dicyclopentadiene-substituted phenol resins; and advanced epoxy-isocyanate copolymers such as those sold commercially as D.E.R. 592 and D.E.R. 6508 (Dow Chemical).

In all of the foregoing cases, any of the epoxy resin(s) contained in the thermosetting resin composition can be liquid at 22° C. provided that the thermosetting resin composition as a whole has is a solid at that temperature and preferably has a Mettler softening temperature as described before.

The epoxy hardener preferably is selected together with any catalyst(s) such that the adhesive cures rapidly when heated to a temperature of at least 50° C. or greater, preferably at least 80° C. or greater, more preferably at least 120° C. or greater, but cures very slowly if at all at room temperature (−22° C.) and temperatures up to the temperature attained in the air floatation dryer. Suitable hardeners include materials such as boron trichloride/amine and boron trifluoride/amine complexes, dicyandiamide, melamine, diallylmelamine, guanamines such as acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones.

The hardener is present in an amount sufficient to cure the epoxy resin. Typically, enough of the curing agent is provided to consume at least 80% of the epoxide groups present in the composition. A large excess over that amount needed to consume all of the epoxide groups is generally not needed.

The catalyst is preferably encapsulated or otherwise a latent type that becomes active only upon exposure to elevated temperatures. The latent types include catalysts that are integrated into a poly(p-vinylphenol) matrix (as described in European patent EP 0 197 892) into a novolac resin (including, for example, those described in U.S. Pat. No. 4,701,378 and WO 2012/000171).

Among preferred epoxy catalysts are ureas such as p-chlorophenyl-N,N-dimethylurea (Monuron), 3-phenyl-1,1 -dimethylurea (Phenuron), 3,4-dichlorophenyl-N,N-dimethylurea (Diuron), N-(3-chloro-4-methylphenyl)-N′,N′-dimethylurea (Chlortoluron), toluene-2,4-dimethyl urea, toluene-2,6-dimethyl urea, tert-acryl- or alkylene amines like benzyldimethylamine, 2,4,6-tris(dimethylaminomethyl)phenol, piperidine or derivatives thereof, various aliphatic urea compounds such as are described in EP 1 916 272; C₁-C₁₂ alkylene imidazole or N-arylimidazoles, such as 2-ethyl-2-methylimidazol, or N-butylimidazol and 6-caprolactam. A preferred catalyst is 2,4,6-tris(dimethyl-aminomethyl)phenol integrated into a poly(p-vinylphenol) matrix (as described in European patent EP 0 197 892), or 2,4,6-tris(dimethylaminomethyl)phenol integrated into a novolac resin (including, for example, those described in U.S. Pat. No. 4,701,378 and WO 2012/000171).

The prepreg of the invention can be used to make reinforced composites. The composite manufacturing process involves shaping the prepreg using any convenient method or combination of methods, and then curing the thermosetting resin. The shaping and/or curing may be performed in a mold, a press or other convenient apparatus. The prepreg may be formed onto a support and/or to other components as may be useful for the particular application for which the part is intended. The curing is generally performed at an elevated temperature sufficient to cure the thermosetting resin in an economically short period of time, such as up to 30 minutes, up to 15 minutes, up to 10 minutes or up to 5 minutes. The curing temperature may be as low as room temperature (22° C.) or up to, for example, 250° C. or more. For the preferred latent curing systems, a preferred curing temperature is 80 to 200° C., especially 120 to 160° C.

The prepregs may be “laid-up” onto a form or substrate to form multiple plies to produce thicker parts. The formed part may be overmolded with a show surface or otherwise coated if desired.

Examples of specific parts that can be made using the prepregs of the invention include frame members, roof pillars, body panels and the like for automobiles, trucks, trains and other land transportation vehicles; aircraft fuselage, wing, aileron, tail and/or rudder panels and frame members; sporting and recreational equipment such as golf club shafts, tennis racket frames, jet-ski bodies, boat hulls, hockey sticks, lacrosse sticks, and the like; personal protective gear such as helmets and body armor; and in various construction applications.

The following examples are provided to illustrate the invention, but are not intended to limit the scope thereof. All parts and percentages are by weight unless otherwise indicated.

### EXAMPLES 1-4 AND COMPARATIVE SAMPLE A

Examples 1-4 and Comparative Sample A are made in the following general manner. Aksaca 24K A-42 carbon fibers from DowAksa Ileri Kompozit Malzemeler Sanayi Ltd, Sti are woven into a 2×2 twill fabric having a width of 0.3 meters. This woven fiber mat has an area density of about 640 g/m². A 30-meter length of the mat is rolled up. A length of leader is attached to one end.

The fiber mat roll is mounted onto an unwinding station of a pilot scale coating/air flotation drying apparatus. The apparatus includes, in sequence, the unwinding station, a coating station, the air flotation dryer; a series of chill rollers and a rewinding station. The leader is threaded through the various stations and connected to a roll mounted on the rewinding station.

The coating station includes a bath and J-bar where the fiber web is immersed in the aqueous dispersion of thermosetting resin, followed by a pair of nip rolls that squeeze excess fluid from the coated fabric and control the coating load to about 440g/m². The air floatation dryer consists of three sections, each about 1.5 meters in length. The air flotation dryer air jet speed is 1500 meters/minute in each of the sections. The temperature set points for the air jets are 127° C., 116° C. and 110° C., respectively, in the three sections.

The thermosetting resin is an aqueous epoxy dispersion containing a heat-activated catalyst and hardener. The system is designed to start curing when exposed to a temperature of 100° C. The water content of the dispersion is about 55% by weight.

The chill rollers are at approximately ambient temperature (about 20° C.).

To make Example 1, the apparatus is operated at a rate of 0.3 meters/minute, to produce a residence time in the dryer of about 15 minutes.

To make Examples 2-4 and Comparative Sample A, respectively, the apparatus is operated at rates of 0.6, 0.9, 1.2 and 1.5 meters/minute to produce residence times of 7.5, 5, 3.75 and 3 minutes, respectively.

For Examples 3 and 4 and Comparative Sample A, the moisture content of the resulting prepreg is measured by weighing a cut sample of the prepreg and then drying it in an oven (during the trial we actually used a Mettler moisture balance) to constant weight. The water content of Examples 3 and 4 and Comparative Sample A are as follows: Example 3: 1.25 weight percent; Example 4: 1.58 weight percent; Comparative Sample A: 4.16 weight percent. These values indicate that under the temperature conditions of the dryer, a residence time of about 4 minutes in the dryer is sufficient to reduce the water content to about 2.25 weight percent or below.

The thermosetting resin in the prepregs exiting the dryer show no signs of advancement, indicating that the temperature of the wet, impregnated fiber mat and prepreg remain below 100° C. in each of Examples 1-4 and Comparative Sample A. Upon exiting the cooling station, the prepregs are solid and non-tacky and are rolled up without a release layer.

Samples are taken from each of Examples 1-4 and Comparative Sample A for molding. The samples are cut into 0.3×0.3 meter squares and stacked into three plies. In each case, duplicate stacks of three plies are compression molded at 150° C. for 5 minutes and at the same temperature for 3 minutes. All mold easily and release from the mold readily even though no mold release agent is used. Moldings made from Examples 3 and 4 and Comparative Sample A are evaluated for tensile strength, tensile modulus and compressive strength according to ASTM D-3039. Results are indicated in the following Table.

TABLE 1

| | Drying | | | | | Compres- |
|---|---|---|---|---|---|---|
| | Speed, | Water | Molding | Tensile | Tensile | sion |
| Desig- | m/ | content, | Time, | Modulus, | Str., | Str., |
| nation | minute | wt-% | min | GPa | MPa | MPa |
| 3 | 0.9 | 1.25 | 3 | 53 | 630 | 161 |
| 3 | 0.9 | 1.25 | 5 | 59 | 640 | 170 |
| 4 | 1.2 | 1.58 | 3 | 54 | 630 | 157 |
| 4 | 1.2 | 1.58 | 5 | 52.5 | 770 | 160 |
| Comp. | 1.5 | 4.16 | 5 | 47 | 630 | 125 |
| A* | | | | | | |

*Not an example of the invention.

As can be seen from the data in Table 1, all samples have good mechanical properties even though the prepregs in each case contain a significant amount of residual water. Comparative Sample A, which has the highest amount of water, shows some loss in tensile modulus and compressive strength.

1. A process for forming a prepreg, comprising;
a) continuously impregnating a fiber mat with an aqueous dispersion containing droplets or particles of an uncured thermosetting resin dispersed in a continuous aqueous phase, to form a wet, impregnated fiber mat and then
b) continuously feeding the wet, impregnated fiber mat through a hot air dryer wherein one or more streams of elevated temperature gas are contacted with the wet, impregnated fiber mat to remove water from the wet, impregnated fiber mat and form a dried prepreg that includes the fiber mat impregnated with a curable, thermosetting resin composition that includes the uncured thermosetting resin, the dried prepreg containing 0 to 2.5% of water based on the total weight of the dried prepreg, and continuously withdrawing the dried coated prepreg from the dryer.

2. The process of claim 1, wherein the elevated temperature gas is introduced into the dryer at a temperature of 100 to 175° C.

3. The process of claim 1, wherein the stream(s) of elevated temperature gas have a flow rate of 5 to 100 m/s at the point(s) of contact with the impregnated fiber mat.

4. The process of claim 1, wherein the dried prepreg has a water content of 1 to 2.25% based on the total weight of the prepreg.

5. The process of claim 1, wherein the dryer is a gas flotation dryer.

6. The process of claim 1, wherein the temperature of the wet-impregnated fiber mat and the dried prepreg do not exceed 100° C. in the dryer.

7. The process of claim 1, wherein the temperature of the wet-impregnated fiber mat and the dried prepreg in the dryer do not exceed the Mettler softening temperature of the thermosetting resin composition.

8. The process of claim 1, wherein the Mettler softening temperature of the thermosetting resin composition is at least 80° C.

9. The process of claim 1, wherein the thermosetting resin composition is a non-tacky solid when dried prepreg exits the dryer.

10. The process of claim 9 wherein the dried prepreg is stacked or wound without a release layer between adjacent dried prepreg surfaces.

11. The process of claim 1, wherein the thermosetting resin composition cures at an elevated temperature of at least 80° C., but does not cure significantly at a temperature below 80° C.

12. The process of claim 1, wherein the thermosetting resin is an epoxy resin.

13. The process of claim 1, further comprising curing the prepreg to form a composite.

14. The process of claim 1, wherein the thermosetting resin composition contains at least one latent curing agent for the thermosetting resin, at least one latent catalyst, or both.
